(19) United States
(12) Patent Application Publication
(10) Pub. No.: US 2007/0048537 A1
(43) Pub. Date: Mar. 1, 2007

(54) Coated Metallic Component

(76) Inventors: Reinhard Knoedler, Sandhausen (DE); Richard Brendon Scarlin, Oberflachs (CH); Christina Tompkin, Baden (CH)

Correspondence Address: CERMAK & KENEALY LLP, 515 E. BRADDOCK RD, SUITE B, ALEXANDRIA, VA, 22314, US

(21) Appl. No.: 11/275,220

(22) Filed: Dec. 20, 2005

Related U.S. Application Data
(63) Continuation of application No. PCT/EP04/51237, filed on Jun. 25, 2004.

(30) Foreign Application Priority Data
Jul. 3, 2003 (EP) 03405497.3

(51) Int. Cl. B32B 15/04; B32B 9/00; B32B 19/00

(52) U.S. Cl. 428/471; 428/469; 428/472; 428/689; 428/615

(57) ABSTRACT

A metallic component includes a base material (1) and a coating that is deposited on the surface of its base material (1) and protects the component from oxidation and/or corrosion. The coating includes two oxidation resistant layers (2,4). The second oxidation resistant layer (4) includes a sol-gel that forms a uniform film (4) on the surface of the first layer (2) and fills any cracks (3) that extend from the surface of the first oxidation resistant layer (2). The first oxidation resistant layer (2) in combination with the sol-gel layer (4) provides an improved high temperature oxidation resistance of the metallic component as the sol-gel (4) prevents oxidizing media from reaching the base material (1) through cracks propagating through the first coating layer (2). As an option, an additional innermost layer of MCrAlY may be applied on the surface of the base material (1).

This application is a Continuation of, and claims priority under 35 U.S.C. § 120 to, International application number PCT/EP2004/051237, filed 25 Jun. 2004, and claims priority to European patent application number 03405497.3, filed 3 Jul. 2003, the entireties of both of which are incorporated by reference herein.

### BACKGROUND OF THE INVENTION

1. Field of the Invention

The invention pertains to a metal component having a coating for protection against exposure to a high temperature oxidizing and/or corroding medium.

2. Brief Description of the Related Art

Components of certain metals oxidize when exposed to a high temperature medium such as air or steam. For example, ferritic and martensitic steels, as used for components in steam power plants oxidize heavily at temperatures above 500° C. due to the formation of iron and chromium oxides. In a steam turbine, the oxidized matter can spall off and damage the turbine and other components. In other metal components such as pipes, heat exchangers, or boilers, the oxides can obstruct the heat flux across a pipe wall and thus inhibit the heat transfer. As temperatures rise to 600 and 700° C., oxidation and its related effects increase also.

It is known that oxidation of ferritic and martensitic steels with 1-13% Cr can be prevented by means of a coating with Al-, Si-, Cr-, Fe- or Ni-base alloys. Such coatings can be applied by various deposition methods such as thermal spraying, dipping, or slurry coating. For example, A. Agüero et al. disclose in “Coatings for steam power plants under advanced conditions”, Proceedings of the 7^{th} Liége Conference: Materials for Advanced Power Engineering 2002, October 2002, p. 1143, the application of slurry aluminide coatings onto P92 and electroless nickel coatings on E911 and their exposure to high temperature steam at 600 to 650° C. There it was presented that the use of these coatings can greatly reduce steam oxidation at these temperatures for long time periods. However, the coatings have been shown to develop cracks either during their application, for example during thermal diffusion treatment, or during operation of the coated component in high temperature steam. Such cracks can propagate to the surface of the substrate material as a result of mechanical bending or of thermally induced stresses during exposure to the high temperature steam. The cracks could allow steam, or any other oxidising medium, to penetrate to the surface of the base material of the component and promote the growth of oxidation scales. Furthermore, such cracks are mechanically undesirable as the cracks can develop into the substrate material itself.

Scarlin et al. disclose in US 2003/00644244 a coating for a metallic component exposed to high temperature steam. The coating comprises a primer layer containing a superalloy and free of cracks and other defects, which is deposited directly on the surface of the base material. An oxidation resistant layer consisting of a Ni—P alloy, Al, Al—Si, or Cr alloy is deposited on the primer layer. The overlay layer provides resistance to both oxidation and mechanical damage to the primer layer whereas the primer layer inhibits oxidation of the base material in the case of cracks penetrating through the overlay layer to the primer layer.

WO 00/70190 discloses a metallic component having an aluminium coating that protects the component from oxidation and is deposited by a diffusion process.

KR 00241233 discloses a method for manufacturing a sol-gel applied to the surface of a steel component. The sol-gel is intended to provide oxidation resistance of the component during heat treatment over a short time period. Following such heat treatment of the component, the sol-gel is again exfoliated.

In general, sol-gel processing is a known wet chemical process for the synthesis of a suspension of small solid particles or clusters about 1 to 1000 nm in size in a liquid or “sol” and subsequent formation of a dual-phase material with a solvent or “wet gel”. The solvent is then removed by a drying process. The process enables the formation of a thin, crack-free, highly pure, and homogeneous film. A thin film of approximately 100 nm thickness can be deposited by low temperature methods such as dipping, spinning, or spray-coating. Thicker films are obtained by multiple applications of such thin films.

It is known that, due to the ceramic nature of sol-gels, certain types of sol-gel coatings resist exposure to high temperatures of more than 600° C.

### SUMMARY OF THE INVENTION

One aspect of the present invention includes providing a metallic component that is oxidation and/or corrosion resistant when exposed to a high temperature oxidising medium for a prolonged time period.

A metallic component comprises a base material and a coating deposited on the surface of the base material that protects the base material from oxidation and/or corrosion comprising a first oxidation resistant layer and a second oxidation resistant layer deposited on the first layer of the coating.

In another aspect of the present invention, the second layer contains a sol-gel that fills and seals cracks or fissures that extend from the surface of the first layer. The sol-gel containing layer may also form a uniform film on the surface of the first layer.

A metallic component embodying principles of the present invention has improved oxidation and/or corrosion resistance at elevated temperatures over components described in the state of the art. The first layer of the coating provides a primary oxidation resistance. This layer may have cracks due to the deposition method and/or due to exposure to high temperatures, which in the worst case extend from the outer surface of the layer to the surface of the base material and present a risk of oxidation of that material. The sol-gel film is able to fill such cracks in the first layer. Due to its nature, the sol-gel not only forms a very smooth film, but also readily fills and seals any surface imperfections such as cracks or fissures. Due to the small size of the suspended solid particles or clusters, the sol-gel readily flows into narrow cracks. Cracks are filled to the extent that no vacant spaces remain and no media can pass down the cracks towards the base material of the metallic component. The sol-gel therefore seals and perfects the first oxidation resistant layer and prevents oxidizing media from reaching the base material.

The sol-gel applied as a single coating layer directly onto the surface of the base material would not provide a sufficient oxidation protection for a metallic component exposed to high temperature oxidizing media. The mechanical resistance of the thin sol-gel is sufficient only to a certain degree because a sol-gel film can erode in such environments.

The first oxidation resistant layer applied as a sole coating layer deposited onto the base material may also not provide sufficient protection because oxidation may occur by oxidizing media passing through cracks, as described above.

The combination, however, of the two layers according to this invention provides an improved oxidation protection over either one of the single layers. The sol-gel film provides additional oxidation protection and improves the quality of the first oxidation resistant layer primarily by sealing its cracks. Due to the inherent thermal resistance of certain sol-gels the oxidation protection of the component is ensured up to temperatures well above 600° C.

Once the metallic component according to the invention is exposed to high temperature oxidizing media, any part of the sol-gel film on the surface of the first oxidation resistant layer may disappear as a result of erosion. The sol-gel in the cracks, however, remains as it is mechanically shielded within the cracks. In case of erosion of the sol-gel film, the component is still protected from oxidation by the first oxidation resistant layer having the sol-gel filling its cracks

Several embodiments of a metallic component according to this invention are presented herein.

In a first exemplary embodiment of the invention, the elements predominantly used for the sol-gel layer match those predominantly used for the first oxidation layer. This means that the base element or the element contained at highest weight percentage in the sol-gel layer and the base element or element contained at highest weight percentage in the first layer are the same. A matching of the materials has the advantage that interdiffusion between atoms in the first layer and the sol-gel layer cause complete healing of the crack. There remains neither a physical nor a chemical discontinuity.

In a second embodiment of the invention, the predominant elements used for the sol-gel differ from the predominant elements used for the first layer. In similar sense as above, this means that the base element of sol-gel layer differs from the base element used for the first layer. During exposure to high temperatures a diffusion process occurs by which the two layers assimilate by interdiffusion of their elements.

Of the above embodiments, the first oxidation resistant layer comprises any element that can be produced as alkoxides such as Zr, Ti, or any one of the following materials: Al, Si, Cr, Ni, Fe, and their alloys, or any combination of the above mentioned materials.

The sol-gel film comprises any one or a combination of the following materials: Al, Si, Cr, Ni, Fe and their alloys.

In all the above embodiments, the base material of the metallic component comprises any one of the following materials: ferritic or martensitic steels containing 1-13% Cr or austenitic steels.

In a variant to all the above embodiments, a primer layer of MCrAlY, where M signifies Ni, Co, Fe, or a combination thereof, is deposited as an additional innermost coating layer onto the surface of the base material and the first oxidation resistant layer is deposited on the surface of the MCrAlY. The primer layer has any one or any combination of the following functions: improving adhesion to the metallic component, providing additional oxidation resistance, or reducing the rate of diffusing of elements between the oxidation resistant layers and the base material of the metallic component.

In a method according to the invention the metallic component is manufactured by the following steps:

The metallic component is coated with the first oxidation resistant layer. For example, the first oxidation resistant layer is applied in the form of a slurry, which is applied by painting or dipping, or by an electrolytic or electroless technique from an aqueous solution. Alternatively, other methods of application, such as thermal spraying, may also be employed. The component is subjected to a thermal diffusion treatment to promote bonding of the first layer with the base material of the component. The sol-gel is deposited on the first oxidation resistant layer. For this step any appropriate method may be used, such as spraying, spinning, or dipping.

Optionally, a subsequent thermal heat treatment may be employed to improve interdiffusion and bonding between the sol-gel layer and the first oxidation resistant layer.

In a further method according to the invention, a metallic component that is coated with an oxidation resistant layer, which has developed cracks extending from its surface either during the manufacturing process or during service operation of the component, is repaired by applying a sol-gel layer onto the surface of the oxidation resistant layer. The sol-gel layer may be applied by any appropriate process, such as spraying, spinning, or dipping.

In a variant, the repairing method includes a further step of mechanically and/or chemically cleaning the surface of the first oxidation layer of the component.

In a further variant, the repair method includes, following the application of the sol-gel layer, a subsequent thermal heat treatment of the component to improve interdiffusion and bonding between the sol-gel layer and the first oxidation resistant layer.

The metallic component according to the invention is applicable in power generation plants, in particular to steam turbines, compressors, components in boilers and heat exchangers, and any application involving high temperature oxidizing environments.

### BRIEF DESCRIPTION OF THE DRAWINGS

FIG. 1 shows a schematic cross-section of one embodiment of a metallic component according to the invention having first and second oxidation resistant layers.

FIG. 2 shows a schematic cross-section of a further embodiment of a metallic component according to the invention and including an additional, innermost layer of the coating.

### DETAILED DESCRIPTION OF EXEMPLARY EMBODIMENTS

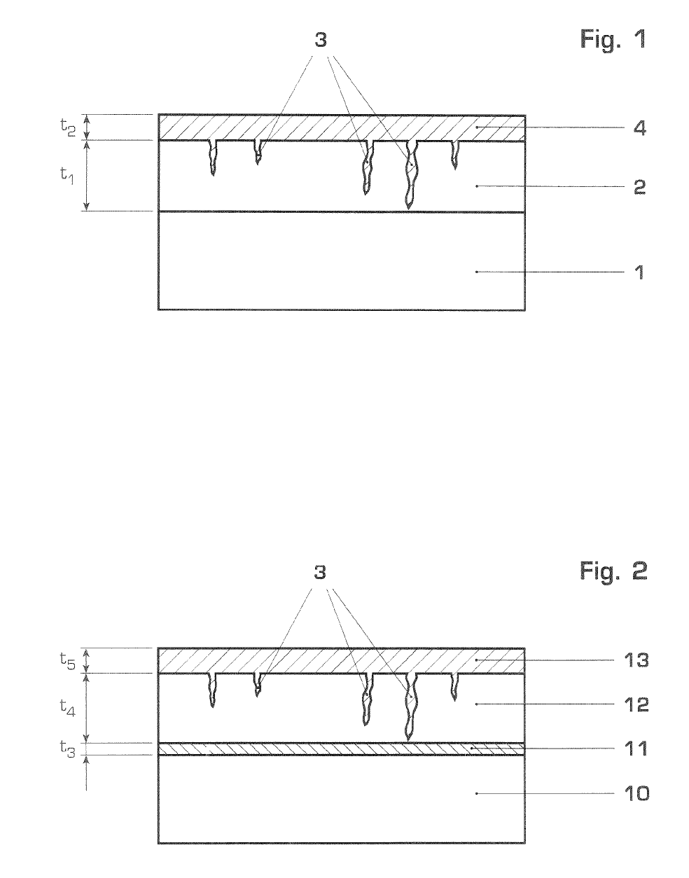

FIG. 1 shows an exemplary embodiment of a metallic component according to the invention. The base material 1 consists of the steel P92 according to the specification by the American Society of Mechanical Engineers (ASME). It is coated with a first oxidation resistant layer 2 containing Al. Aluminium provides a good oxidation resistance at high temperatures up to 700° C. and more. Such a layer should have a minimal thickness t₁ of 10 microns in order to add a sufficient quantity of Al to the surface region of the component, thereby ensuring a sufficient lifetime of the coating, whereas a thickness of 200 microns is typically sufficient for all applications. In this embodiment the thickness is approximately 50 microns.

Such a coating may be applied using low-cost and low temperature methods such as slurry painting or dipping. Alternatively, a coating containing a combination of materials, for example including one or more of the materials Al, Si, Cr, or Ni may be applied by the same or another method. After the material has been applied it is subjected to a thermal diffusion process, for example at temperatures of 700° C. for a time period of 10 hours.

The thermal diffusion process continues during high temperature exposure of the component when put into operation. During the diffusion process cracks 3 can form at the surface of the first oxidation layer and propagate towards the base material. A second oxidation resistant layer 4 is deposited on top of the first layer 2, this second layer 4 formed of one or several sol-gel films containing aluminium. Alternatively, Si-based, Fe-based, Cr-based, or Ni-based alloys or a combination thereof may be used.

The sol-gel layer has a minimal thickness t₂ of 1 micron for reasons that a minimal thickness is required in order to ensure filling of the cracks whereby a thickness of 10 microns sufficiently provides the function it is intended for. This thickness may be reached by applying several films of the sol-gel.

A sol-gel film is produced by using a known method, including, for example, the following steps:

mixing of an alkoxide precursor, such as Tetramethoxysilane with alcohol solvent and water and a catalyst. The resulting sol is cast onto the surface, where gelation causes a solid to be formed. The gel (Xerogel) is aged to allow strengthening (polymerization). The gel is then dried to remove the liquid.

FIG. 2 shows a variant of the metallic component according to the invention. The base material 10 consists of E911 according to ASME specifications. Its surface is coated with a primer layer 11 of MCrAlY having a thickness t₃ of approximately 10 microns. This layer provides significantly improved adhesion and a dense coating that is free of cracks.

A first oxidation resistant layer 12 containing Al and Si is deposited on the surface of the primer layer 11 in the form of a painted slurry. This layer has a preferred thickness t₄ in the range of 10 to 200 microns

A second oxidation resistant layer 13 formed of a sol-gel layer contains a combination of Al, Si, Fe, Ni, and Cr and has a preferred thickness t₅ Of 1-10 microns.

The described coated metallic components have a resistance to high temperature oxidation up to temperatures of 700° C., some as high as 800° C. depending on the materials used for the base, first and second oxidation resistant layer.

While the invention has been described in detail with reference to exemplary embodiments thereof, it will be apparent to one skilled in the art that various changes can be made, and equivalents employed, without departing from the scope of the invention. Each of the aforementioned documents is incorporated by reference herein in its entirety.

What is claimed is:

1. A metallic component comprising:
a base material; and
a coating deposited on the surface of the base material comprising a first oxidation resistant layer and a second oxidation resistant layer deposited on the first layer;
wherein the second oxidation resistant layer comprises a sol-gel having filled and sealed any cracks extending from the surface of the first layer.

2. A metallic component according to claim 1, wherein the first oxidation resistant layer comprises predominantly the same elements as the second oxidation resistant layer.

3. A metallic component according to claim 1, wherein the first oxidation resistant layer comprises predominantly different elements than those of the second oxidation resistant layer.

4. A metallic component according to claim 1, wherein the first oxidation resistant layer comprises any element produced as an alkoxide, or any one or combination of Al, Si, Cr, Ni, Fe, and alloys thereof.

5. A metallic component according to claim 1, wherein the second oxidation resistant layer comprises a sol-gel film comprising any one or a combination of Al, Si, Cr, Ni, Fe, and alloys thereof.

6. A metallic component according to claim 1, wherein the base material comprises a material selected from the group consisting of ferritic steels, martensitic steels containing 1-13% Cr, and austenitic steels.

7. A metallic component according to claim 1, further comprising:
a primer layer containing MCrAlY, wherein M is an element selected from the group consisting of Ni, Co, Fe, and combinations thereof, deposited as an additional and innermost coating layer onto the surface of the base material; and
wherein the first oxidation resistant layer is deposited on the surface of the primer layer.

8. A metallic component according to claim 1, wherein the first oxidation resistant layer has a thickness in the range from 10 to 200 microns.

9. A metallic component according to claim 1, wherein the second oxidation resistant layer has a thickness in the range from 1 to 10 microns.

10. A method of fabricating a metallic component according to claim 1, the method comprising:
coating the metallic component with the first oxidation resistant layer;
subjecting the component to thermal diffusion; and
depositing a sol-gel layer onto the surface of the first oxidation resistant layer.

11. A method according to claim 10, further comprising:
following the deposition of the sol-gel layer, further heat treating the metallic component.

12. A method of repairing a metallic component having a base material and a first oxidation resistant layer deposited on the surface of the base material, said first oxidation resistant layer having cracks extending from its surface towards the base material, the method comprising:
depositing, onto the surface of the first oxidation resistant layer, a second oxidation resistant layer comprising a sol-gel; and
polymerization, gelation, and drying of the sol-gel layer.

13. A method of repairing a metallic component according to claim 12, further comprising:
mechanical cleaning, chemical cleaning, or both, of the surface of the first oxidation resistant layer prior to said depositing the sol-gel layer.

14. A metallic component comprising:
a component of a steam turbine, of a compressor, of a boiler, or of a heat exchanger; and
wherein the component comprises a component according to claim 1.
